(19) United States
(12) Patent Application Publication
(10) Pub. No.: US 2023/0012076 A1
(43) Pub. Date: Jan. 12, 2023

(54) OBJECT DETECTION DEVICE

(71) Applicant: DENSO CORPORATION, Kariya-city, Aichi-pref. (JP)

(72) Inventor: Fumiaki MIZUNO, Kariya-city, Aichi-pref. (JP)

(21) Appl. No.: 17/932,575

(22) Filed: Sep. 15, 2022

Related U.S. Application Data
(63) Continuation of application No. PCT/JP2021/009243, filed on Mar. 9, 2021.

(30) Foreign Application Priority Data
Mar. 19, 2020 (JP) 2020-048828
Jan. 25, 2021 (JP) 2021-009395

(51) Int. Cl. G01S 17/04; G01S 7/481

(52) U.S. Cl. CPC G01S 17/04; G01S 7/4811; G01S 7/4817

(57) ABSTRACT

An object detection device includes: a light emitter that emits laser light as irradiation light; a light receiver that receives light including reflected light of the irradiation light; a plurality of constituents that perform operations to detect information on an object through operations of the light emitter and the light receiver and that have an increased current period in which a consumed current is a current larger than an average current; a common power supply that supplies power to the plurality of constituents; and a controller that controls the operations of the plurality of constituents so as to make a current output from the common power supply less than a predetermined upper-limit current.

### CROSS REFERENCE TO RELATED APPLICATION

This application is the U.S. bypass application of International Application No. PCT/JP2021/009243 filed on Mar. 9, 2021, which designated the U.S. and claims priority to Japanese Patent Application Nos. 2020-048828 and 2021-009395, filed on Mar. 19, 2020 and Jan. 25, 2021 respectively, the contents of both of these are incorporated herein by reference.

### BACKGROUND

### Technical Field

The present disclosure relates to an object detection device.

### Description of the Related Art

As an object detection device, a scanning laser radar is known. The scanning laser radar is configured to project laser light and receive light reflected on an object to detect the presence or absence of an object and information on an object, such as distance to the object.

The object detection device described above is considered to include, in addition to an actuator for scanning, a plurality of components that consume a large current, such as a temperature adjuster that adjusts the temperature of a light emitter and a temperature adjuster that adjusts the temperature of a light receiver to stably emit and receive the laser light, and a temperature adjuster that adjusts the temperature of a window for emitting and receiving the laser light.

### SUMMARY

An object detection device of the present disclosure includes: a light emitter that emits laser light as irradiation light; a light receiver that receives light including reflected light of the irradiation light; a plurality of constituents that perform operations to detect information on an object through operations of the light emitter and the light receiver and that have an increased current period in which a consumed current is a current larger than an average current; a common power supply that supplies power to the plurality of constituents; and a controller that controls the operations of the plurality of constituents so as to make a current output from the common power supply less than a predetermined upper-limit current.

### BRIEF DESCRIPTION OF THE DRAWINGS

The object described above, other objects, features, and advantages of the present disclosure are more clarified by the detailed description below with reference to the accompanying drawings. The drawings include:

FIG. 1 is a schematic configuration diagram of an object detection device according to a first embodiment;

FIG. 2 is a timing chart illustrating an example of drive currents in the first embodiment;

FIG. 3 is a timing chart illustrating drive currents of a comparative form;

FIG. 4 is a timing chart illustrating an example of drive currents in a second embodiment; and

FIG. 5 is a schematic configuration diagram of an object detection device according to a third embodiment.

### DETAILED DESCRIPTION OF THE PREFERRED EMBODIMENTS

As a conventional art, Japanese Patent Laid-open Publication No. 2019-128221 discloses, as an object detection device, a scanning laser radar that projects laser light and receives light reflected on an object to detect the presence or absence of an object and information on an object, such as distance to the object.

The object detection device described above is considered to include, in addition to an actuator for scanning, a plurality of components that consume a large current, such as a temperature adjuster that adjusts the temperature of a light emitter and a temperature adjuster that adjusts the temperature of a light receiver to stably emit and receive the laser light, and a temperature adjuster that adjusts the temperature of a window for emitting and receiving the laser light. In order to simultaneously supply peak currents consumed in these components to the components, a power supply is required including a battery that can supply he total value of the peak currents of the components, an overcurrent protection circuit, and the like, and this causes an increase in the size of the power supply used. In addition, when the timing of consuming the peak currents of the components is varied and the current output from the power supply is greatly varied, the output voltage of the power supply is greatly varied accordingly.

Hereinafter, embodiments of the present disclosure will be described with reference to the drawings.

### First Embodiment

An object detection device is a scanning radar (also called “LiDAR: Light Detection and Ranging”) that radiates laser light as irradiation light and receives light including reflected light from a target to detect the presence or absence of a target and information on an object such as distance to the target.

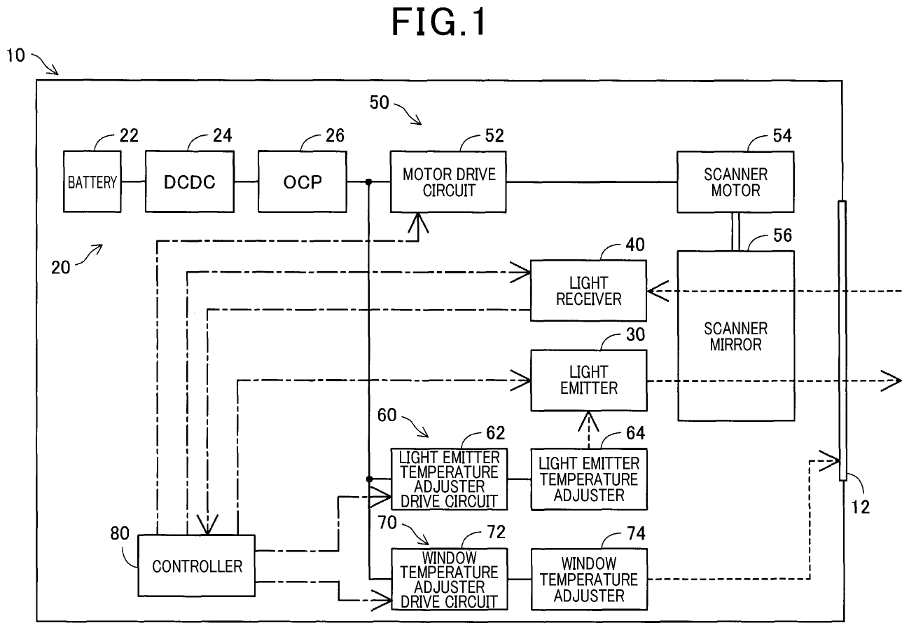

As illustrated in FIG. 1, an object detection device 10 according to an embodiment includes a common power supply 20, a light emitter 30, a light receiver 40, a scanner 50, a light emitter temperature adjusting section 60, a window temperature adjusting section 70, and a controller 80.

The light emitter 30 includes a light emitting element (not illustrated) that emits laser light and a light emission control circuit (not illustrated) that controls the light emitting element, and the light emitter 30 emits the laser light as irradiation light according to control by the controller 80. The irradiation light emitted from the light emitter 30 is emitted outside the object detection device 10 via a scanner mirror 56 of the scanner 50 described later and a window 12 disposed on a housing.

The scanner 50 includes the scanner mirror 56 that reflects the irradiation light emitted from the light emitter 30, a scanner motor 54 that rotates the scanner mirror 56, and a motor drive circuit 52 that drives the scanner motor 54. The scanner motor 54 is, for example, a rotary solenoid, is driven by the motor drive circuit 52 according to control of the controller 80, and repeats forward rotation and reverse rotation within a predetermined angle range (also called an “angle of view range”). As a result, the scanner 50 can perform reciprocating scanning with the irradiation light through the rotation of the scanner mirror 56 in a scanning range with an angle specified by the window 12. The scanner motor 54 is not limited to the rotary solenoid and can be any actuator that can repeat forward rotation and reverse rotation in an angle range corresponding to the scanning range and perform reciprocating scanning with the irradiation light.

When there is an object (hereinafter, also called a “target”) such as a human or a car in the scanning range, the irradiation light emitted from the light emitter 30 is diffusely reflected on the surface of the object and a part of the diffused light is returned as reflected light to the scanner mirror 56 via the window 12. This reflected light is reflected with other external light on the scanner mirror 56 and received by the light receiver 40.

The light receiver 40 includes a plurality of light receiving elements and a light reception control circuit (both not illustrated), and outputs, to the controller 80 according to control of the controller 80, a light reception signal based on the light reception state of the plurality of light receiving elements. The controller 80 detects the presence or absence of a target and information on an object, such as distance to the target, on the basis of the light reception signal received from the light receiver 40.

The light emitter temperature adjusting section 60 includes a light emitter temperature adjuster 64 that adjusts the temperature of the light emitter 30 and a light emitter temperature adjuster drive circuit 62 that drives the light emitter temperature adjuster 64. The light emitter temperature adjuster 64 is driven by the light emitter temperature adjuster drive circuit 62 and adjusts the temperature of the light emitter 30 according to the control of the controller 80. This enables the light emitter 30 to generate the laser light in a stable wavelength band that can be received by the light receiver 40. Applicable as the light emitter temperature adjuster 64 is not only temperature adjusters, such as a heater and a Peltier element, but also various temperature adjusters such as a temperature adjuster with heating and cooling ability.

The window temperature adjusting section 70 includes a window temperature adjuster 74 that adjusts the temperature of the window 12 and a window temperature adjuster drive circuit 72 that drives the window temperature adjuster 74. The window temperature adjuster 74 is driven by the window temperature adjuster drive circuit 72 and adjusts the temperature of the window 12 according to the control of the controller 80. This enables freezing and clouding of the window 12 to be removed and stably enables the irradiation light to be emitted to the outside and the reflected light to be incident to the inside. As the window temperature adjuster 74, various temperature adjusters are applicable similarly to the light emitter temperature adjuster 64. Hereinafter, the light emitter temperature adjuster 64 and the window temperature adjuster 74 are described as temperature adjusters that adjust the temperature by turn-on and turn-off as heaters do.

The common power supply 20 includes a battery 22, a direct current voltage conversion circuit (described as “DCDC” in the drawing) 24, and an overcurrent protection circuit (described as “OCP” in the drawing) 26. The direct current voltage conversion circuit 24 converts a direct current voltage output from the battery 22 to a direct current voltage that can be supplied to the motor drive circuit 52, the light emitter temperature adjuster drive circuit 62, and the window temperature adjuster drive circuit 72. The overcurrent protection circuit 26 shuts off the supply of power to each of the circuits when an overcurrent is detected as the current supplied to each of the circuits. The light emitter 30, the light receiver 40, and the controller 80 have power supplied similarly to the motor drive circuit 52, the light emitter temperature adjuster drive circuit 62, and the window temperature adjuster drive circuit 72 or through a power supply circuit (not illustrated) connected to the battery 22. For the convenience of describing the embodiment, however, such a configuration is not illustrated.

The controller 80 includes, for example, a microcomputer, and by a CPU executing a preliminarily arranged program, the controller 80 executes the control necessary to detect an object for the light emitter 30, the light receiver 40, the motor drive circuit 52 of the scanner 50, the light emitter temperature adjuster drive circuit 62 of the light emitter temperature adjusting section 60, and the window temperature adjuster drive circuit 72 of the window temperature adjusting section 70. Particularly, the controller 80 controls, as described below, the motor drive circuit 52, the light emitter temperature adjuster drive circuit 62, and the window temperature adjuster drive circuit 72 and thus reduces a peak value of the current (hereinafter, also called a “peak current”) supplied from the battery 22.

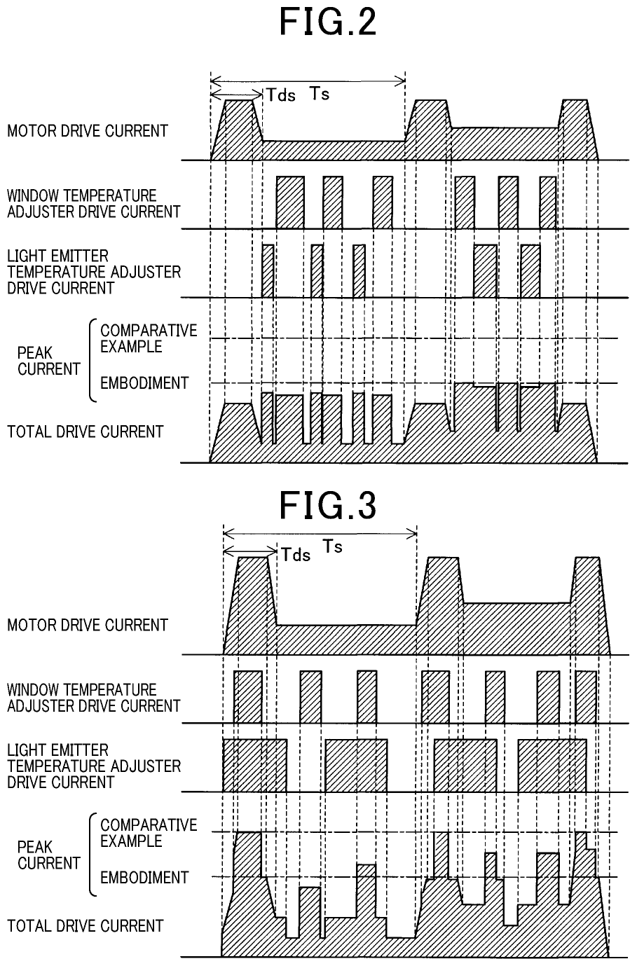

When the reciprocating scanning with the irradiation light is performed as described above, the motor drive circuit 52 switches the rotation direction of the scanner motor 54 with a scanning period (also called a “frame period”). In the switching, as illustrated in FIGS. 2 and 3, the scanner motor 54 requires, as a motor drive current necessary in a certain period Tds which is an earlier period in a scanning period Ts and in which the scan direction is switched, a current several times to tens of times larger than the current necessary in a period other than the period Tds. As illustrated in FIGS. 2 and 3, the light emitter temperature adjuster 64 and the window temperature adjuster 74 require, as a drive current necessary in a period of performing a temperature adjusting operation, a current larger than the current in a period of not performing the temperature adjusting operation. The drive currents illustrated in FIGS. 2 and 3 are schematically illustrated for easy description, and each of the actual drive currents is a current that varies in the period corresponding thereto and is a current that is, as a whole, larger in the period corresponding thereto than the current in the other period. A peak value (hereinafter, also called a “peak current”) generated in the period Tds of the motor drive current is larger than a peak value (peak current) of the drive current in the operation period of the light emitter temperature adjuster and a peak value (peak current) of the drive current generated in the operation period of the window temperature adjuster, and the consumed power of the scanner motor 54 is larger than the consumed power of the light emitter temperature adjuster 64 and the consumed power of the window temperature adjuster 74.

Here, described as comparative forms are the case when the light emitter temperature adjuster 64 and the window temperature adjuster 74 overlap the operations thereof in the period Tds in which the motor drive current is the peak current and the case when the light emitter temperature adjuster 64 and the window temperature adjuster 74 overlap the operations thereof in the period other than the period Tds. As illustrated in FIG. 3, required in the period Tds is a drive current obtained by totaling the peak value (peak current) of the motor drive current, the peak value of the current generated in the operation period of the light emitter temperature adjuster (hereinafter, also called “a peak current of a light emitter temperature adjuster drive current”), and the peak value of the current generated in the operation period of the window temperature adjuster (hereinafter, also called “a peak current of a window temperature adjuster drive current”). As illustrated in FIG. 3, in the period other than the period Tds, there are cases in which a drive current is required that is substantially smaller than the drive current in the period Tds, i.e., a drive current obtained by totaling the peak current of the light emitter temperature adjuster drive current and the peak current of the window temperature adjuster drive current. As a result, the battery 22 is required to tolerate the output of power corresponding to the total of these drive currents. Therefore, there is a problem of causing an increase in the size of a power supply used as the battery 22. There is also a problem of increasing the variation in the output voltage of the battery 22 because, as illustrated in FIG. 3, the total of the drive currents overlapped is greatly varied according to the operation timing of the scanner motor 54, the light emitter temperature adjuster 64, and the window temperature adjuster 74. There is also a problem of causing an increase in the size of the device when not the common power supply 20 but separate power supplies are used for the scanner 50, the light emitter temperature adjusting section 60, and the window temperature adjusting section 70.

In contrast, the controller 80 (see FIG. 1) of the object detection device 10 according to the embodiment performs the control so as not to allow the light emitter temperature adjuster 64 and the window temperature adjuster 74 to operate (ON) in the period Tds (illustrated in FIG. 2) in which the motor drive current is the peak current. That is, the controller 80 performs the control so as not to allow, in the period Tds in which the motor drive current is the peak current, the overlap of the period in which the light emitter temperature adjuster drive current is the peak current and the period in which the window temperature adjuster drive current is the peak current. By this control, the total drive current required as the output current of the common power supply 20 in the period Tds can only be the peak current of the motor drive current. In addition, the controller 80 performs the control so as not to allow overlapped operations (ON) of the light emitter temperature adjuster 64 and the window temperature adjuster 74 in the period (illustrated in FIG. 2) other than the period Tds. That is, the controller 80 performs the control so as not to allow, in the period other than the period Tds, the overlap of the period in which the light emitter temperature adjuster drive current is the peak current and the period in which the window temperature adjuster drive current is the peak current. By this control, the total drive current required as the output current of the common power supply 20 in the period other than the period Tds can only be the overlap of the motor drive current which is a fraction of the peak current to one-several tenth the peak current thereof, and the peak current of either one of the light emitter temperature adjuster drive current and the window temperature adjuster drive current.

Accordingly, the object detection device 10 can reduce the current required as the output current of the common power supply 20 in the scanning period Ts to less than the predetermined upper-limit current and reduce the current compared with the current in the comparative form illustrated in FIG. 3. This enables the size of connectors and wiring connecting the power supply with the components to be reduced. This can also improve the problem of an increase in the size of a power supply used as the battery 22 and including a battery, an overcurrent protection circuit, and the like. This can also improve the problem of increasing the variation in the output voltage of the battery 22. This can also improve the problem of an increase in the size of the device because the device includes the common power supply 20 for the scanner 50, the light emitter temperature adjusting section 60, and the window temperature adjusting section 70.

The motor drive current in the period Tds is a current including the peak current several times to tens of times larger than the current in the other period (Ts-Tds) and can be regarded as a current larger than the average current of the motor drive current. Accordingly, the period Tds in which the motor drive current is the peak current may be regarded as an increased current period in which the motor drive current is a current larger than the average current thereof. The light emitter adjuster drive current in the period of turning on the light emitter temperature adjuster is also a current including the peak current substantially larger than the light emitter adjuster drive current in the period of turning off the light emitter temperature adjuster, and can be regarded as a current larger than the average current of the light emitter adjuster drive current. Accordingly, the period in which the light emitter temperature adjuster drive current is the peak current may be regarded as an increased current period in which the light emitter temperature adjuster drive current is a current larger than the average current thereof. As to the window temperature adjuster drive current, the period in which the window temperature adjuster drive current is the peak current may, similarly to the light emitter temperature adjuster drive current, be regarded as an increased current period in which the window temperature adjuster drive current is a current larger than the average current thereof. The controller may be configured to control the adjustment amounts, i.e., the current amounts of the drive currents when the temperature adjusters are operated (ON).

The scanner 50, the light emitter temperature adjusting section 60, and the window temperature adjusting section 70 in the description above correspond to “the plurality of constituents” in the present embodiment. The scanner 50 corresponds to “the standard constituent element”, and the light emitter temperature adjusting section 60 and the window temperature adjusting section 70 correspond to “the other constituents”. The motor drive current corresponds to “the consumed current of the scanner”, the light emitter temperature adjuster drive current corresponds to “the consumed current of the temperature adjusting section”, and the window temperature adjuster drive current corresponds to “the consumed current of the window temperature adjusting section”. The period in which the motor drive current is the peak current corresponds to “the current peak period in which the consumed current of the scanner is a current larger than the average current thereof with a constant period”, and corresponds to “the increased current period in which the consumed current of the scanner is a current larger than the average current thereof”. The period in which the light emitter temperature adjuster drive current is the peak current corresponds to “the current peak period in which the consumed current of the light emitter temperature adjusting section is a current larger than the average current thereof, that is, the increased current period”, and the period in which the window temperature adjuster drive current is the peak current corresponds to “the current peak period in which the consumed current of the window temperature adjusting section is a current larger than the average current thereof, that is, the increased current period”.

### Second Embodiment

As described below, an object detection device according to a second embodiment is the same as the object detection device 10 according to the first embodiment except the way of controlling the temperature adjusting sections. Therefore, the configuration of the object detection device according to the second embodiment is not illustrated and described.

In the first embodiment, the control was performed so as not to allow overlapped operations of the light emitter temperature adjuster 64 and the window temperature adjuster 74 in the period (Ts-Tds) other than the period Tds that is the peak current period of the scanner 50 and thus so as not to allow the overlap of the increased current period in which the light emitter temperature adjuster drive current is the peak current and the increased current period in which the window temperature adjuster drive current is the peak current (see FIG. 2). That is, the adjustment is performed so as not to allow the overlap of the timing of supplying the light emitter temperature adjuster drive current from the common power supply 20 and the timing of supplying the window temperature adjuster drive current from the common power supply 20.

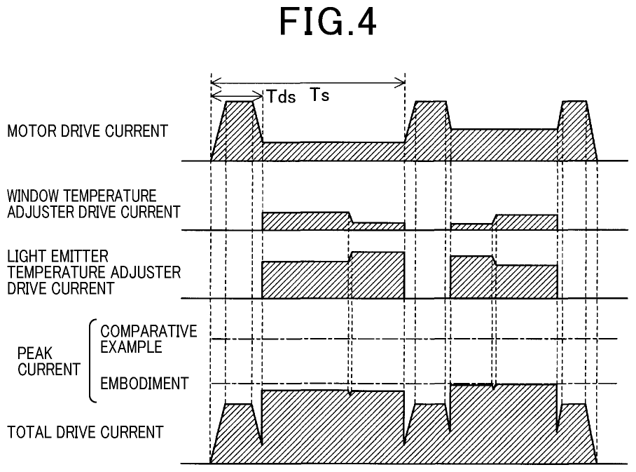

Alternatively, as illustrated in FIG. 4, the output current of the common power supply 20 may be reduced to less than the predetermined upper-limit current by allowing overlapped operations of the light emitter temperature adjuster 64 and the window temperature adjuster 74 in the period (Ts-Tds) other than the period Tds, and adjusting the current amount of the light emitter temperature adjuster drive current and the current amount of the window temperature adjuster drive current. For example, the current amount of each of the drive currents may be adjusted by controlling the adjustment amount of temperature with respect to the target temperature of each of the temperature adjusters so as not to make the total current amount of the drive currents equal to or more than the upper-limit current. This case can also provide the similar effects to the effects of the first embodiment.

In the period (Ts-Tds), the period in which the drive currents for the temperature adjusters are adjusted corresponds to the increased current period in which the drive currents are larger than the average currents thereof, in consideration of the period Tds in which the drive currents are not flowed.

In the second embodiment, described as an example in the timing chart illustrated in FIG. 4 is the case of adjusting the drive currents for the temperature adjusters over the whole period (Ts-Tds). The adjustment, however, is not limited to this example. For example, in the cases where the drive currents for the temperature adjusters are overlapped in a part of the period, the adjustment amount of temperature with respect to the target temperature of each of the temperature adjusters may be controlled in the overlapped period so as not to make the total current amount of the drive currents for the temperature adjusters equal to or more than the upper-limit current. Specifically, for example, the current amount of each of the drive currents may be adjusted in the overlapped period of ON operations of the temperature adjusters by controlling the turn-on and turn-off of the operation of each of the temperature adjusters.

### Third Embodiment

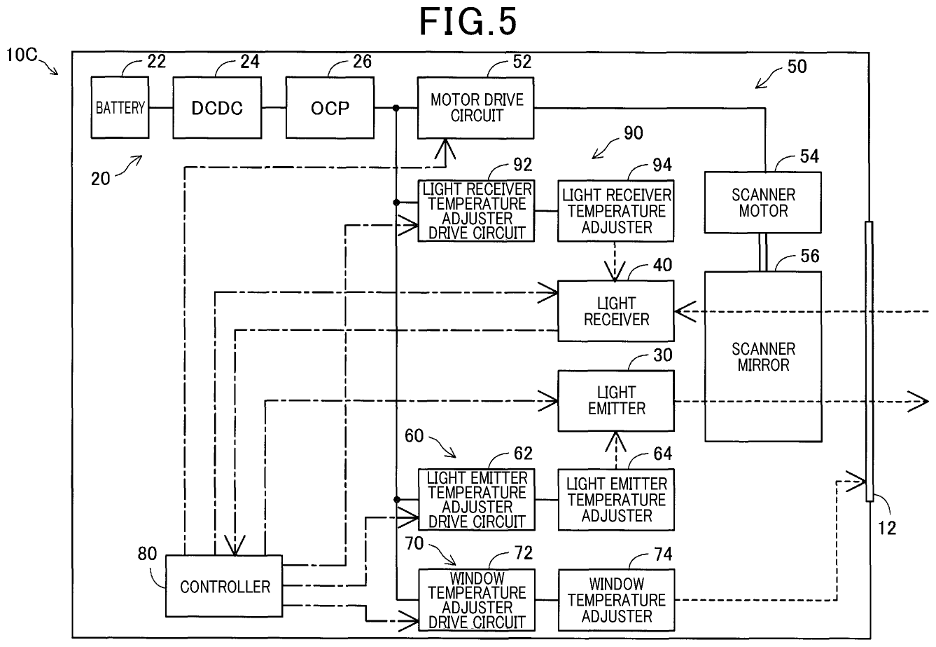

As illustrated in FIG. 5, an object detection device 10C according to a third embodiment is different from the object detection device 10 (see FIG. 1) according to the first embodiment in including a light receiver temperature adjusting section 90 in addition to the configuration of the object detection device 10. The light receiver temperature adjusting section 90 includes a light receiver temperature adjuster 94 that adjusts the temperature of the light receiver 40 and a light receiver temperature adjuster drive circuit 92 that drives the light receiver temperature adjuster 94. The light receiver temperature adjuster 94 is driven by the light receiver temperature adjuster drive circuit 92 and adjusts the temperature of the light receiver 40 according to the control of the controller 80.

As described in the first embodiment (see FIG. 2), the operations of the light emitter temperature adjusting section 60, the window temperature adjusting section 70, and the light receiver temperature adjusting section 90 may be controlled so as not to allow overlapped operations of the light emitter temperature adjuster 64, the window temperature adjuster 74, and the light receiver temperature adjuster 94 in the period (Ts-Tds) other than the period Tds that is the peak current period of the scanner 50. That is, control may be performed so as not to allow the overlap of the increased current period in which the light emitter temperature adjuster drive current is the peak current, the increased current period in which the window temperature adjuster drive current is the peak current, and the increased current period in which the light receiver temperature adjuster drive current is the peak current. Alternatively, as described in the second embodiment (see FIG. 4), the current amount of the light emitter temperature adjuster drive current, the current amount of the window temperature adjuster drive current, and the current amount of the light receiver temperature adjuster drive current may be adjusted by allowing overlapped operations of the light emitter temperature adjuster 64, the window temperature adjuster 74, and the light receiver temperature adjuster 94.

The plurality of light receiving elements of the light receiver 40 each normally have a bandpass filter (not illustrated) and receive light with a wavelength having passed the bandpass filter. The bandpass characteristics of a bandpass filter are generally changed depending on the temperature. Therefore, when the temperature of the light receiver 40 is adjusted by the light emitter temperature adjusting section 60, the characteristics of the bandpass filters can be stabilized. This enables the plurality of light receiving elements of the light receiver 40 to have a stable light reception state.

When the object detection device includes the light receiver temperature adjusting section 90, the light emitter temperature adjusting section 60 can be omitted. In this case, for example, the temperature of the light receiver 40 may be adjusted such that the bandpass characteristics of the bandpass filters in the light receiver 40 include the wavelength bands of the laser light that change according to the change in the temperature of the light emitter 30. This also enables the plurality of light receiving elements of the light receiver 40 to have a stable light reception state.

The scanner 50, the light emitter temperature adjusting section 60, the window temperature adjusting section 70, and the light receiver temperature adjusting section 90 in the description above correspond to “the plurality of constituents” in the present embodiment. The scanner 50 corresponds to “the standard constituent element”, and the light emitter temperature adjusting section 60, the window temperature adjusting section 70, and the light receiver temperature adjusting section 90 correspond to “the other constituents”.

### Other Embodiments

(1) In the first and second embodiments, described as examples are the object detection devices configured to include the scanner 50, the light emitter temperature adjusting section 60, and the window temperature adjusting section 70 as the constituents to which a current is supplied from the common power supply. The object detection device, however, is not limited to this configuration. For example, the object detection device may have a configuration of omitting the window temperature adjusting section 70 or the light emitter temperature adjusting section 60. In this case, the timing of supplying a current from the common power supply 20 to each of the constituents or the supplied current amount may be adjusted so as not to overlap, with the peak current period of the scanner 50, the increased current period of the light emitter temperature adjusting section 60 or the window temperature adjusting section 70 included as the constituent element.

In the third embodiment, described as an example is the object detection device configured to include the scanner 50, the light emitter temperature adjusting section 60, the window temperature adjusting section 70, and the light receiver temperature adjusting section 90 as the constituents to which a current is supplied from the common power supply. The object detection device, however, is not limited to this configuration. The object detection device may have a configuration of omitting either one or both the light emitter temperature adjusting section 60 and the window temperature adjusting section 70. When the object detection device includes the light receiver temperature adjusting section 90 as the constituent element, the timing of supplying a current from the common power supply 20 to the constituent element or the supplied current amount may be adjusted so as not to overlap the increased current period of the light receiver temperature adjusting section 90 with the peak current period of the scanner 50. When the object detection device includes, as the constituents, the light receiver temperature adjusting section 90 and either one of the light emitter temperature adjusting section 60 and the window temperature adjusting section 70, the timing of supplying a current from the common power supply 20 to each of the constituents or the supplied current amount may be adjusted so as not to overlap, with the peak current period of the scanner 50, the increased current period of the light receiver temperature adjusting section 90 and the increased current period of either one of the light emitter temperature adjusting section 60 and the window temperature adjusting section 70.

The constituents of the object detection device are not limited to the scanner 50, the light emitter temperature adjusting section 60, the window temperature adjusting section 70, and the light receiver temperature adjusting section 90. Constituents such as a washing device that washes a window and an angle adjusting device that adjusts the angle of the whole object detection device in the vertical or horizontal direction may be applied as the constituents to which power is supplied from the co-power supply. That is, various constituents are applicable that perform operations to detect information on an object through projecting laser light as irradiation light and receiving light including reflected light of the irradiation light and that have an increased current period in which a consumed current is a current larger than an average current.

(2) In the first embodiment, the scanner 50 whose consumed power is the largest is set to be the standard constituent element, and the light emitter temperature adjusting section 60 and the window temperature adjusting section 70 are set to be the other constituents. On the basis of the peak current period of the motor drive current of the scanner 50, the timing of supplying a current from the common power supply 20 to the other constituents, i.e., the light emitter temperature adjusting section 60 and the window temperature adjusting section 70, that is, the operation timing of the light emitter temperature adjusting section 60 and the window temperature adjusting section 70 is adjusted. The timing adjustment, however, is not limited to this case.

For example, when the consumed power of the light emitter temperature adjusting section 60 is the largest with the largest peak current, the operation timing of the scanner 50 and the window temperature adjusting section 70 may be adjusted so as not to allow the overlap of the peak current period of the scanner 50 and the peak current period of the window temperature adjusting section 70 with respect to the peak current period of the light emitter temperature adjusting section 60. The same applies to when the consumed power of the window temperature adjusting section 70 is the largest with the largest peak current. The same applies to the second and third embodiments. Alternatively, a plurality of constituents may be set as the standard constituents.

(3) From the description of the embodiments and the other embodiments (1) and (2), the object detection device according to the present disclosure may be configured as follows. That is, the operations of the plurality of constituents may be controlled so as to make a current output from the common power supply less than a predetermined upper-limit current, the plurality of constituents being configured to perform operations to detect information on an object through projecting laser light as irradiation light and receiving light including reflected light of the irradiation light, and having an increased current period in which a consumed current is a current larger than an average current.

(4) The present disclosure can also be implemented in various forms other than the object detection device. For example, the present disclosure can be implemented in the forms such as a vehicle including an object detection device, an object detection method, a computer program for implementing these device and method, and a storage medium that stores this computer program.

(5) The controller and the approach thereof described in the present disclosure may be implemented by a dedicated computer provided to include a processor and a memory, the processor being programed to execute one or a plurality of functions embodied by a computer program. Alternatively, the controller and the approach thereof described in the present disclosure may be implemented by a dedicated computer provided to include a processor including one or more dedicated hardware logic circuits. Alternatively, the controller and the approach thereof described in the present disclosure may be implemented by one or more dedicated computers provided to include a combination of a processor and a memory with a processor including one or more hardware logic circuits, the processor being programed to execute one or a plurality of functions. The computer program may be stored as an instruction executed by a computer in a computer-readable non-transitory tangible recording medium.

The present disclosure is not limited to the embodiments described above, but can be implemented in various configurations without departing from the gist thereof. For example, the technical features of the embodiments corresponding to the technical features in the forms described in the section Summary of the Invention can be replaced or combined with each other as appropriate to partially or entirely solve the problems described above or to partially or entirely achieve the effects described above. In addition, when not described as essential in the present description, the technical features can be deleted as appropriate.

### CONCLUSION

As described in the foregoing embodiments, according to one form of the present disclosure, an object detection device is provided. This object detection device includes: a light emitter that emits laser light as irradiation light; a light receiver that receives light including reflected light of the irradiation light; a plurality of constituents that perform operations to detect information on an object through operations of the light emitter and the light receiver and that have an increased current period in which a consumed current is a current larger than an average current; a common power supply that supplies power to the plurality of constituents; and a controller that controls the operations of the plurality of constituents so as to make a current output from the common power supply less than a predetermined upper-limit current.

In this object detection device, the current output from the common power supply can be made less than the predetermined upper-limit current, so that an increase in the size of the common power supply can be suppressed and the variation in the output voltage of the common power supply can be suppressed.

What is claimed is:

1. An object detection device comprising:
a light emitter that emits laser light as irradiation light;
a light receiver that receives light including reflected light of the irradiation light;
a plurality of constituents that perform operations to detect information on an object through operations of the light emitter and the light receiver and that have an increased current period in which a consumed current is a current larger than an average current;
a common power supply that supplies power to the plurality of constituents; and
a controller that controls the operations of the plurality of constituents so as to make a current output from the common power supply less than a predetermined upper-limit current.

2. The object detection device according to claim 1, wherein
the plurality of constituents include at least one standard constituent element having, as the increased current period, a peak current period that occurs with a constant period, and
the controller adjusts a current supplied from the common power supply to another constituent element than the standard constituent element on the basis of the peak current period of the standard constituent element so as not to overlap the increased current period of other constituent elements with the peak current period.

3. The object detection device according to claim 2, wherein
the controller adjusts timing of supplying the current from the common power supply to other constituent elements in a period between the peak current periods.

4. The object detection device according to claim 2, wherein
the controller adjusts an amount of the current supplied from the common power supply to other constituent elements in the period between the peak current periods.

5. The object detection device according to claim 2, comprising:
a scanner that corresponds to the standard constituent element and performs reciprocating scanning with the irradiation light; and
a light emitter temperature adjusting section that corresponds to the other constituent element and adjusts temperature of the light emitter.

6. The object detection device according to claim 2, comprising:
a scanner that corresponds to the standard constituent element and performs reciprocating scanning with the irradiation light; and
a light receiver temperature adjusting section that corresponds to the other constituent element and adjusts temperature of the light receiver.

7. The object detection device according to claim 2, comprising:
a scanner that corresponds to the standard constituent element and performs reciprocating scanning with the irradiation light; and
a light emitter temperature adjusting section that adjusts temperature of the light emitter, and a light receiver temperature adjusting section that adjusts temperature of the light receiver, both the temperature adjusting sections corresponding to other constituent elements.

8. The object detection device according to claim 5, further comprising
a window through which the irradiation light is emitted to an outside and the reflected light is incident from the outside, and
further comprising, as the other constituent element, a window temperature adjusting section that adjusts temperature of the window.

9. The object detection device according to claim 2, further comprising:
a window through which the irradiation is emitted to an outside and the reflected light is incident from the outside;
a scanner that corresponds to the standard constituent element and performs reciprocating scanning with the irradiation light; and
a window temperature adjusting section that corresponds to the other constituent element and adjusts temperature of the window.

10. The object detection device according to claim 3, wherein
consumed power of the standard constituent element is larger than consumed power of the other constituent element.
